(19) United States
(12) Patent Application Publication
(10) Pub. No.: US 2019/0083357 A1
(43) Pub. Date: Mar. 21, 2019

(54) LIQUID DRUG TRANSFER DEVICE WITH SET-UP VIAL RETENTION FLEX MEMBERS

(71) Applicant: MEDIMOP Medical Projects Ltd., Ra'anana (IL)

(72) Inventors: Uri DAVID, Nes Ziona (IL); Igor DENENBURG, Gedera (IL)

(73) Assignees: MEDIMOP Medical Projects Ltd., Ra'anana (IL); MEDIMOP Medical Projects Ltd., Ra'anana (IL)

(21) Appl. No.: 15/742,963

(22) PCT Filed: Jul. 18, 2016
(86) PCT No.: PCT/IL2016/050782

§ 371 Date: Jan. 9, 2018

Related U.S. Application Data
(60) Provisional application No. 62/194,489, filed on Jul. 20, 2015.

(51) Int. Cl. A61J 1/20

(52) U.S. Cl. CPC A61J 1/2065; A61J 1/201; A61J 1/2096; A61J 1/2089; A61J 1/2055

(57) ABSTRACT

A liquid drug transfer device for use with an injection vial which includes a vial adapter having a puncturing cannula for puncturing a vial stopper and a fluid transfer port in flow communication with the puncturing cannula. The vial adapter includes set-up vial retention flex members for vial retention purposes in a set-up position without puncturing an injection vial and activation vial retention flex members for vial retention purposes in an activation position puncturing the injection vial.

### FIELD OF THE INVENTION

The invention relates to liquid drug transfer devices in general and liquid drug transfer devices including a vial adapter in particular.

### BACKGROUND OF THE INVENTION

Liquid drug reconstitution assemblages with an irremovable injection vial are known in the art. The term “irremovable” implies an injection vial after attachment to a liquid drug transfer device cannot be detached without damaging one or both of the liquid drug transfer device and the injection vial. One approach involves preventing detachment of an injection vial by preventing access thereto. Another approach involves sufficiently securely pre-attaching an injection vial to preclude detachment.

US Patent Application Publication No. US 2008/0015496 entitled Safety Device For a Bottle For Medical Use employs the former approach. The safety device includes a chamber for completely covering a bottle during the use thereof and spring tabs with free ends directed towards the interior of the chamber. The safety device can be designed to transfer liquid drug from a bottle to an infusion bag or a needleless syringe.

Commonly assigned PCT International Application No. PCT/IL2014/050327 entitled Drug Container Closure for Mounting on Open Topped Drug Container to Form Drug Reconstitution Assemblage for use with Needleless Syringe published under WO 2014/170888 employs the latter approach. The drug reconstitution assemblage includes a tubular closure housing with snap fit members for securely mounting on an injection vial and a fluid transfer member having a puncturing cannula for displacement with respect to the tubular closure housing from an initial set-up position with a non-punctured intact injection vial to a subsequent flow communication position with a punctured injection vial for liquid drug reconstitution for administration purposes.

### SUMMARY OF THE INVENTION

The present invention is directed toward liquid drug transfer devices having a similar vial adapter construction as the aforementioned US 2008/0015496 safety devices insofar as their vial adapters include activation vial retention flex members for vial retention purposes in an activation position puncturing the injection vial equivalent to the US 2008/0015496 spring tabs. The liquid drug transfer devices of the present invention differ from the aforementioned US 2008/0015496 safety devices insofar as their vial adapters additionally include set-up vial retention flex members for vial retention purposes in a set-up position without puncturing an injection vial. The vial adapters can be implemented in a wide range of liquid drug transfer devices for use with a needleless syringe, an infusion bag, and the like. The liquid drug transfer devices of the present invention can be supplied with a pre-attached injection vial in a set-up position to form a ready-to-use liquid drug reconstitution assemblage.

### BRIEF DESCRIPTION OF DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a perspective view of a ready-to-use liquid drug reconstitution assemblage including a first embodiment of a liquid drug transfer device in accordance with the present invention and an injection vial in a set-up position and longitudinal cross section lines A-A and B-B;

FIG. 2 is a perspective view of the ready-to-use liquid drug reconstitution assemblage in an activation position and longitudinal cross section lines A-A and B-B;

FIG. 3 is a longitudinal cross section of the injection vial;

FIG. 4 is an exploded view of the liquid drug transfer device;

FIG. 5A and FIG. 5B are longitudinal cross sections of the liquid drug transfer device correspondingly along line A-A and line B-B;

FIG. 6A and FIG. 6B are longitudinal cross sections of FIG. 1's liquid drug reconstitution assemblage correspondingly along line A-A and line B-B;

FIG. 7A and FIG. 7B are longitudinal cross sections of FIG. 2's liquid drug reconstitution assemblage correspondingly along line A-A and line B-B;

FIG. 8 is an exploded view of a first alternative construction of the FIG. 1's liquid drug transfer device in accordance with the present invention;

FIG. 9 is a perspective view of a second alternative construction of the FIG. 1's liquid drug transfer device in accordance with the present invention;

FIG. 10 is a perspective view of a second embodiment of a liquid drug transfer device in accordance with the teachings of the present invention; and

FIG. 11 is a perspective view of a third embodiment of a liquid drug transfer device in accordance with the teachings of the present invention.

### DETAILED DESCRIPTION OF PREFERRED EMBODIMENTS OF THE INVENTION

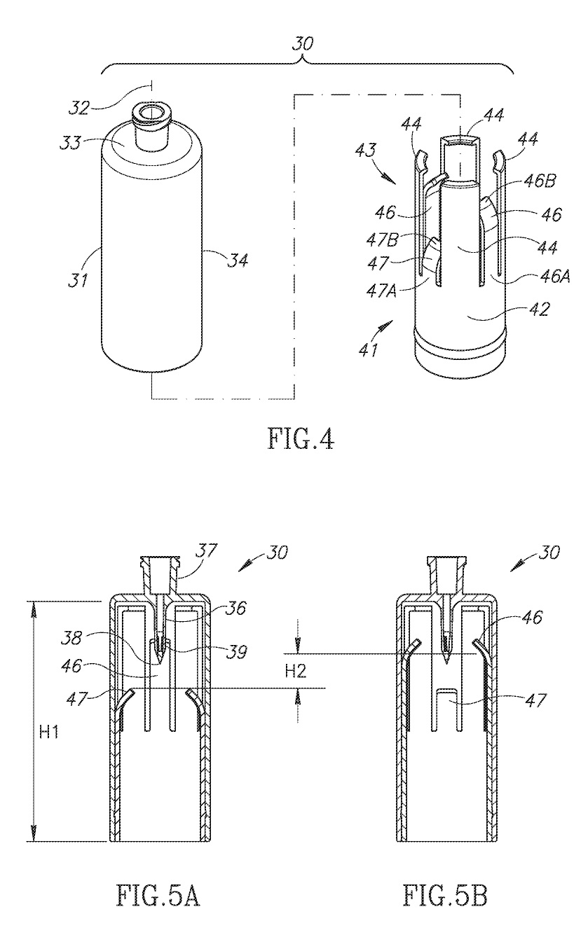

FIGS. 1 to 5 show a ready-to-use liquid drug reconstitution assemblage 10 including an injection vial 20 pre-inserted in a liquid drug transfer device 30 constituted by a female vial adapter. The injection vial 20 has a longitudinal injection vial centerline 21 and includes a closed end vial tube 22, a tubular vial crown 23 having a crown opening 24 and a narrow diameter vial neck 26 intermediate the vial tube 22 and the vial crown 23. The injection vial 20 includes a vial shoulder 27 intermediate the vial tube 22 and the vial neck 26. The injection vial 20 includes a vial stopper 28 stopping the crown opening 24. The injection vial 20 includes a medicament 29 in liquid form or powder form requiring reconstitution to form a liquid drug. The injection vial 20 can be under vacuum. The injection vial 20 has an overall height H1 and the vial crown 23 has a height H2.

The female vial adapter 30 includes a vial adapter 31 having a longitudinal vial adapter centerline 32 and a transverse vial adapter top wall 33 transverse thereto. The female vial adapter 30 includes a substantially cylindrical skirt 34 downwardly depending from the vial adapter top wall 33 for telescopically slidingly receiving the injection vial 20 therein. The skirt 34 preferably has the same height H1 as the injection vial 20 such that the injection vial 20 is flush with the skirt 34 on full insertion of the injection vial 20 thereinto in an activation position.

The vial adapter top wall 33 has a downward depending hollow puncturing cannula 36 for puncturing an injection vial 20 and an upright fluid transfer port 37 constituted by a female Luer connector in flow communication with the puncturing cannula 36. The puncturing cannula 36 has a puncturing cannula tip 38 with a flow aperture 39 for accessing an injection vial 20.

The skirt 34 includes a discrete vial retention flex member structure 41 mounted therein. The vial retention flex member structure 41 has a solid section 42 distal to the vial adapter top wall 33 and a slotted section 43 proximate to the vial adapter top wall 33. The solid section 42 is about a third of the height of the skirt 34. The slotted section 43 includes four equispaced spacers 44 for abutting against the vial adapter top wall 33, a diametric pair of activation vial retention flex members 46 proximal to the vial adapter top wall 33 and a diametric pair of set-up vial retention flex members 47 distal to the vial adapter top wall 33. The set-up vial retention flex members 47 are preferably orthogonal to the activation vial retention flex members 46.

The discrete vial retention flex member structure 41 can optionally include additional activation vial retention flex members 46 and additional set-up vial retention flex members 47 in which case the former 46 have a first radial arrangement with respect to the longitudinal vial adapter centerline 32 and the latter 47 have a second radial arrangement with respect to the longitudinal vial adapter centerline 32 different from the first radial arrangement.

Each activation vial retention flex member 46 has an upright section 46A ending at a free tip 46B inwardly inclined towards the longitudinal vial adapter centerline 32. The free tips 46B are separated from the vial adapter top wall 33 by a height slightly less than the vial crown's height H2 such that the activation vial retention flex members 46 urge the injection vial 20 against the vial adapter top wall 33 on full insertion of the injection vial 20 into the skirt 34.

Each set-up vial retention flex member 47 has an upright section 47A ending at a free tip 47B inwardly inclined towards the longitudinal vial adapter centerline 32. The free tips 47B are separated from the upright sections 46A by a height slightly less than the vial crown's height H2 such that the vial crown 23 is snugly disposed therebetween in the set-up position. The skirt 34 lightly secures the injection vial 20 in the set-up position and prevents inadvertent puncturing of the vial stopper 28. The injection vial 20 outwardly flexes the set-up vial retention flex members 47 against the skirt 34 on full insertion thereinto.

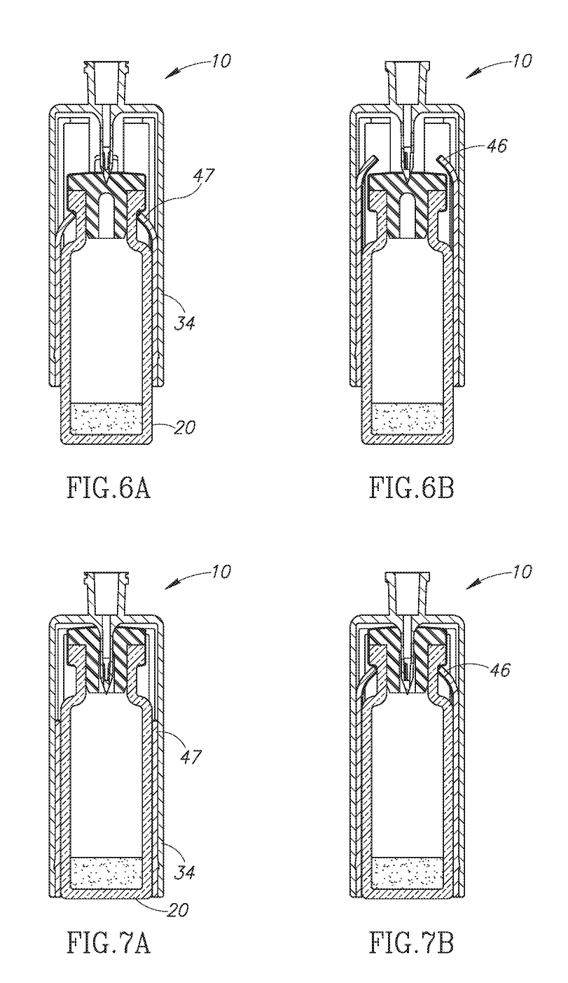

FIGS. 6A and 6B show the ready-to-use liquid drug reconstitution assemblage 10 in FIG. 1's set-up position with the vial crown 23 disposed between the set-up vial retention flex members 47 and the activation vial retention flex members 46. The injection vial 20 extends beyond the skirt 34 by the vial crown's height H2. The puncturing cannula 36 does not puncture the vial stopper 28 for fluid communication with the vial tube 22. The set-up vial retention flex members 47 are designed to break on forced removal of the injection vial 20 from the vial adapter 31.

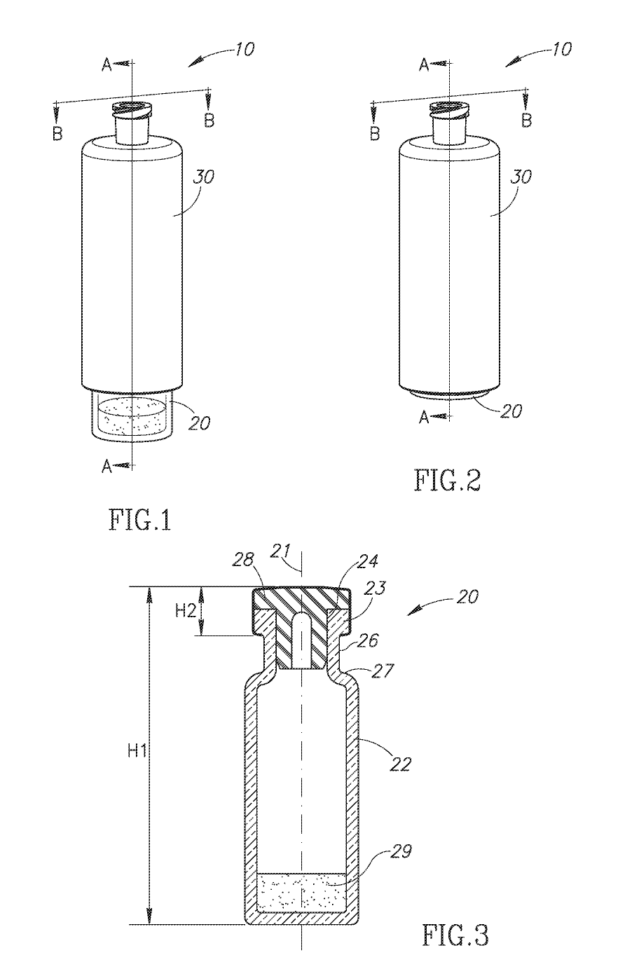

FIGS. 7A and 7B show the ready-to-use liquid drug reconstitution assemblage 10 in FIG. 2's activation position with the vial crown 23 disposed between the vial adapter top wall 33 and the activation vial retention flex members 46 and the puncturing cannula 36 puncturing the vial stopper 28. The injection vial 20 is flush with the skirt 34 thereby precluding access thereto for removing same from the female vial adapter 30. A needleless syringe containing diluent can be attached to the liquid drug reconstitution assemblage 10 for reconstitution purposes and subsequent aspiration of liquid drug contents from the injection vial 20.

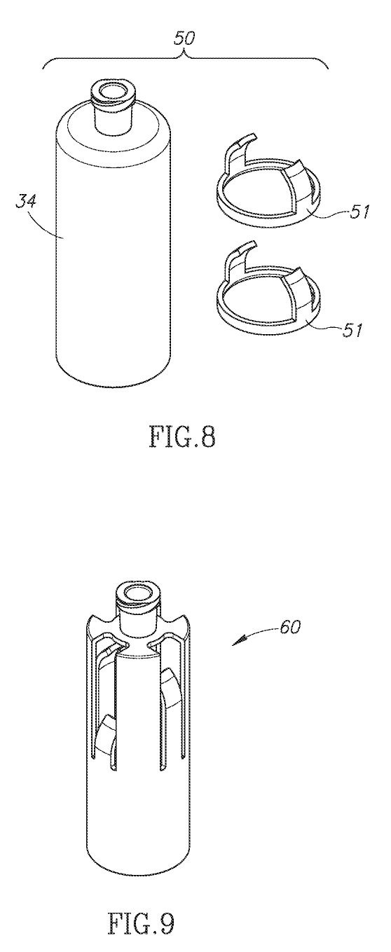

FIG. 8 shows a liquid drug transfer device 50 similar in construction to the liquid drug transfer device 30 and differing therefrom insofar as it includes two discrete vial retention flex member rings 51 instead of the vial retention flex member structure 41. The discrete vial retention flex member rings 51 are mounted in the skirt 34 in a spaced apart arrangement to constitute the activation vial retention flex members 46 and the set-up vial retention flex members 47.

FIG. 9 shows a liquid drug transfer device 60 similar in construction to the liquid drug transfer device 30 and differing therefrom insofar as it includes a unitary construction of the skirt 34 and the vial retention flex member structure 41.

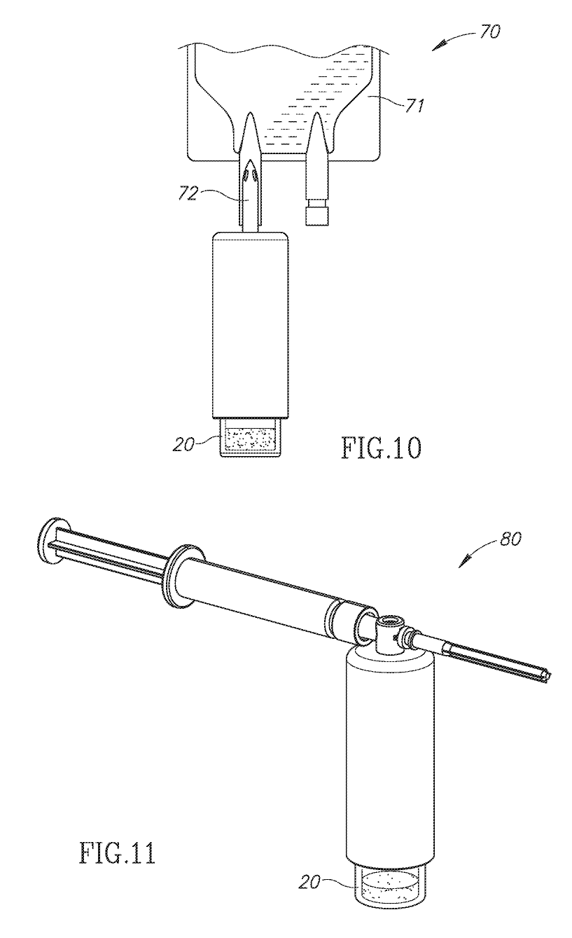

FIG. 10 shows a liquid drug transfer device 70 intended for use with an IV bag 71. The liquid drug transfer device 70 is similar in construction as the liquid drug transfer device 30 and differs therefrom insofar as it includes an IV spike 72 instead of the fluid transport port 37.

FIG. 11 shows a liquid drug transfer device 80 constituted by a fluid control device disclosed in commonly owned U.S. Pat. No. 6,238,372 to Zinger et al. and including a vial adapter in accordance with the teaching of the present invention.

While particular embodiments of the present invention are illustrated and described, it would be obvious to those skilled in the art that various other changes and modifications can be made without departing from the spirit and scope of the invention.

1-8. (canceled)

9. A liquid drug transfer device for use with an injection vial, the injection vial having a longitudinal injection vial centerline and including a closed end vial tube, a tubular vial crown having a crown opening stopped by a vial stopper, the injection vial having a height H1, and a narrow diameter vial neck intermediate the vial tube and the vial crown, the liquid drug transfer device comprising:
(a) a vial adapter having a longitudinal vial adapter centerline and including a transverse vial adapter top wall transverse to said longitudinal vial adapter centerline, a substantially cylindrical skirt downwardly depending from said vial adapter top wall for telescopically slidingly receiving at least the vial crown therein, and a hollow puncturing cannula for puncturing the vial stopper, said puncturing cannula having a puncturing cannula tip with at least one flow aperture for accessing the vial tube, said skirt including
i) at least two activation vial retention flex members proximal to said vial adapter top wall for snap fitting over the vial crown for vial retention purposes in a flow communication position with said puncturing cannula puncturing the vial stopper, and
ii) at least two set-up vial retention flex members spaced apart from said at least two activation vial retention flex members for snap fitting over the vial crown for vial retention purposes in a set-up position wherein the vial crown is disposed between said at least two activation vial retention flex members and said at least two set-up vial retention flex members on an initial sliding insertion of the vial crown in said skirt and without said puncturing cannula puncturing the vial stopper; and
(b) a fluid transfer port in flow communication with said puncturing cannula wherein
said set-up vial retention flex members are designed to break on forced removal of the injection vial from said vial adapter in said set-up position, and
said skirt has the height H1 such that, in use, said skirt telescopically receives the injection vial therein such that the injection vial is flush with said skirt in the flow communication position, thereby precluding access to the injection vial for removal from said vial adapter.

10. The device according to claim 9 wherein said skirt includes a discrete vial retention flex member structure mounted therein, said discrete vial retention flex member structure including said at least two activation vial retention flex members and said at least two set-up vial retention flex members.

11. The device according to claim 9 wherein said skirt includes two discrete vial retention flex member rings mounted therein in a spaced apart arrangement to constitute said at least two activation vial retention flex members and said at least two set-up vial retention flex members.

12. The device according to claim 9 wherein said skirt, said at least two activation vial retention flex members and said at least two set-up vial retention flex members are of a unitary construction.

13. A liquid drug reconstitution assemblage including a liquid drug transfer device according to claim 9 and an injection vial inserted in said liquid drug transfer device in said set-up position.
